(19) United States
(12) Patent Application Publication
(10) Pub. No.: US 2016/0355129 A1
(43) Pub. Date: Dec. 8, 2016

(54) Vehicle Safety Assembly

(71) Applicants: John Scott, Brampton (CA); Marilia Palma, Brampton (CA)

(72) Inventors: John Scott, Brampton (CA); Marilia Palma, Brampton (CA)

(21) Appl. No.: 14/731,128

(22) Filed: Jun. 4, 2015

(51) Int. Cl. B60Q 9/00; B60K 35/00

(52) U.S. Cl. CPC B60Q 9/00; B60K 35/00; B60K 2350/965

(57) ABSTRACT

A vehicle safety assembly includes a housing that may be positioned within a vehicle. A control circuit is positioned within the housing and a display is coupled to the housing. A plurality of remote units is provided and each of the remote units may be distributed around four sides of the vehicle. Thus, each of the remote units detects wind. Each of the remote units is in communication with the display. The display displays an alert when a detected wind speed exceeds the trigger wind speed thereby alerting a driver of the vehicle to the detected wind.

### BACKGROUND OF THE DISCLOSURE

### Field of the Disclosure

The disclosure relates to safety devices and more particularly pertains to a new safety device for alerting a driver of a vehicle to high speed wind.

### SUMMARY OF THE DISCLOSURE

An embodiment of the disclosure meets the needs presented above by generally comprising a housing that may be positioned within a vehicle. A control circuit is positioned within the housing and a display is coupled to the housing. A plurality of remote units is provided and each of the remote units may be distributed around four sides of the vehicle. Thus, each of the remote units detects wind. Each of the remote units is in communication with the display. The display displays an alert when a detected wind speed exceeds the trigger wind speed thereby alerting a driver of the vehicle to the detected wind.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a vehicle safety assembly according to an embodiment of the disclosure.

FIG. 2 is a bottom view of an embodiment of the disclosure.

FIG. 3 is a right side view of an embodiment of the disclosure.

FIG. 4 is a perspective in-use view of an embodiment of the disclosure.

FIG. 5 is a schematic view of an embodiment of the disclosure.

### DESCRIPTION OF THE PREFERRED EMBODIMENT

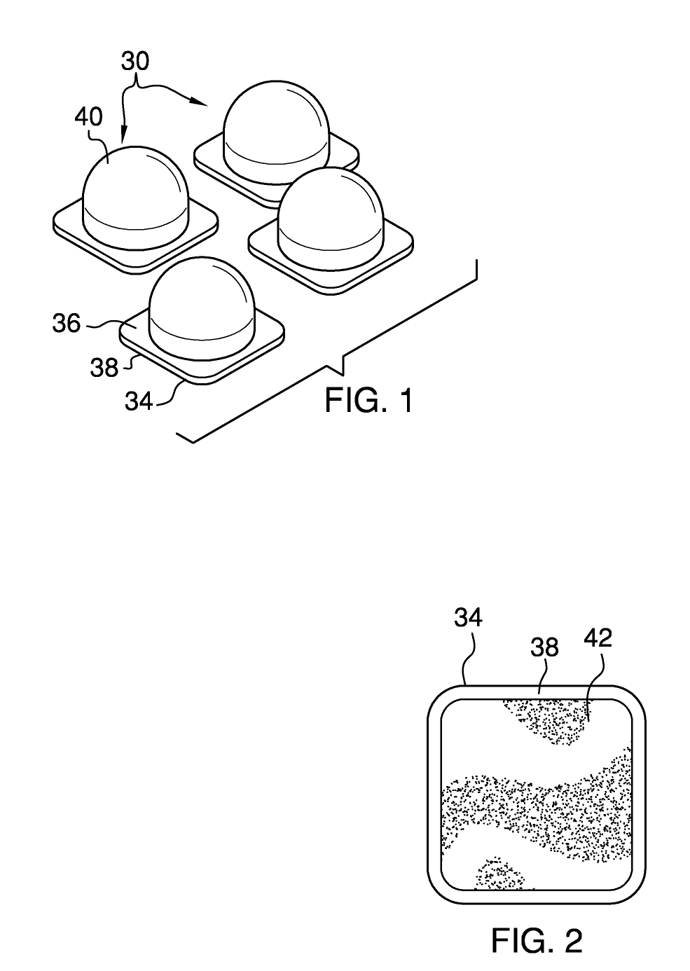

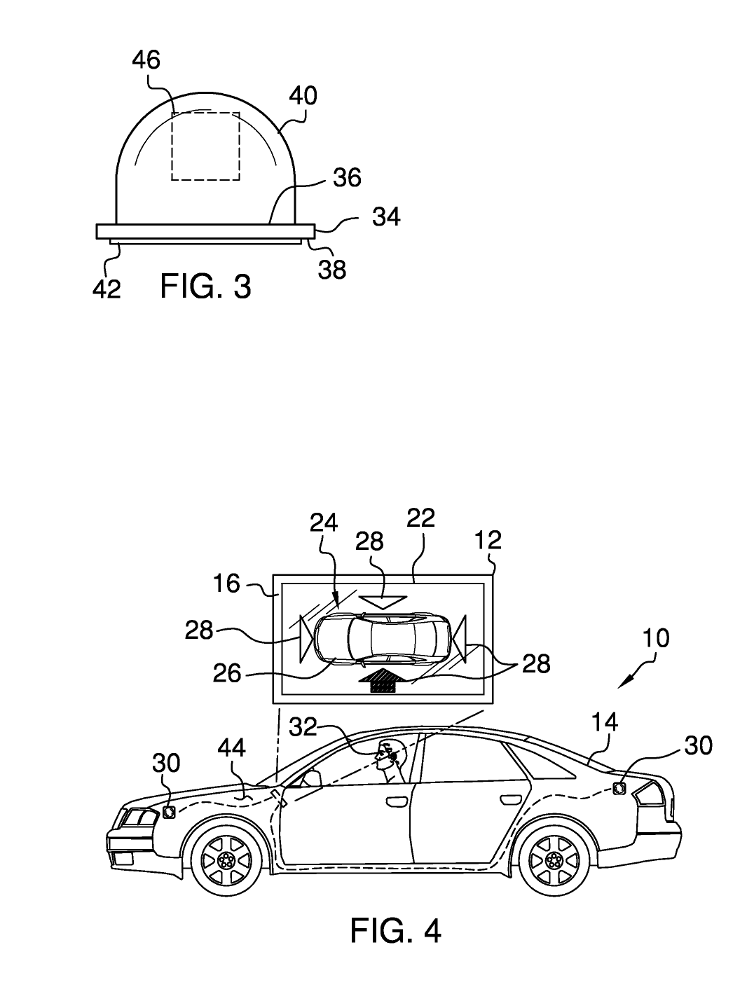

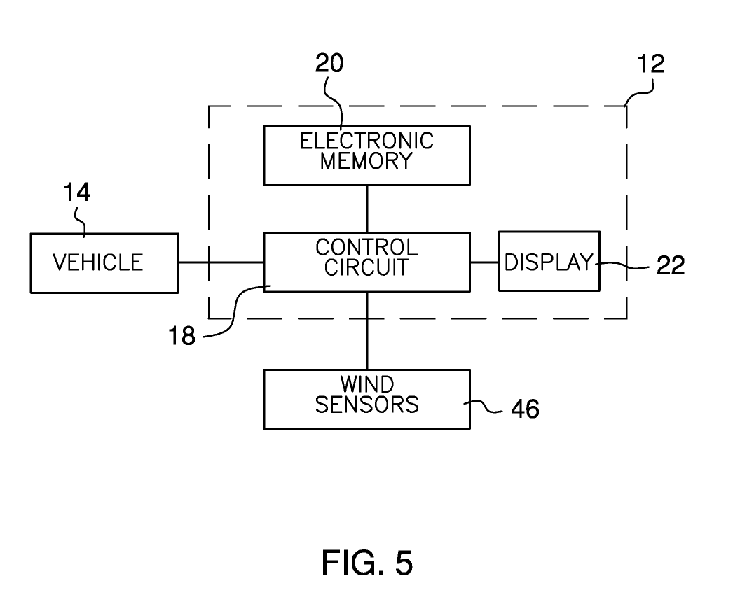

With reference now to the drawings, and in particular to FIGS. 1 through 5 thereof, a new safety device embodying the principles and concepts of an embodiment of the disclosure and generally designated by the reference numeral 10 will be described.

As best illustrated in FIGS. 1 through 5, the vehicle safety assembly 10 generally comprises a housing 12 that may be positioned within a vehicle 14. The vehicle 14 may be a passenger vehicle or the like and the housing 12 has a front side 16. A control circuit 18 is positioned within the housing 12 and the control circuit 18 is electrically coupled to the vehicle 14. The control circuit 18 includes an electronic memory 20 and the electronic memory 20 contains a pre-determined trigger wind speed. The control circuit 18 may comprise an electronic processor or the like and the electronic memory 20 may comprise ROM memory or the like.

A display 22 is coupled to the housing 12 and the display 22 is positioned on the front side 16. The display 22 is electrically coupled to the control circuit 18 and the display 22 displays indicia 24. The indicia 24 comprise an image of a vehicle 26 and a plurality of arrows 28. Each of the arrows 28 points toward an associated one of four sides of the image of the vehicle 26. The display 22 may comprise an LED display or the like.

A plurality of remote units 30 is provided and the remote units 30 may be distributed around four sides of the vehicle 14 wherein each of the remote units 30 detects wind. Each of the remote units 30 is in communication with the display 22. The display 22 displays an alert when a detected wind speed exceeds the trigger wind speed thereby alerting a driver 32 of the vehicle 14 to the detected wind. Each of the remote units 30 comprises a base 34 that has a top side 36 and a bottom side 38 and a dome 40 that is coupled to the top side 36. The dome 40 is comprised of a rigid and air permeable material such that wind may pass through the dome 40. The bottom side 38 of each of the remote units 30 has an adhesive layer 42 attached thereto. The adhesive layer 42 adhesively engages an outside surface 44 of the vehicle 14 such that the remote units 30 are retained on the vehicle 14. The remote units 30 may be distributed around four sides of the vehicle 14.

A plurality of wind sensors 46 is provided and each of the wind sensors 46 is attached to an associated one of the remote units 30. Thus, each of the wind sensors 46 detects a direction and a speed of wind. Each of the wind sensors 46 is positioned beneath the dome 40 on the associated remote unit wherein each of the wind sensors is exposed to wind. Each of the wind sensors 46 is electrically coupled to the control circuit 18. The display 22 displays an alert when a detected wind speed exceeds the trigger wind speed. The alert comprises one of the arrows 28 on the display 22 being illuminated corresponding to a direction of the detected wind with respect to the vehicle 14. Each of the wind sensors 46 may be electronic wind sensors of any conventional design.

In use, each of the remote units 30 is attached to vehicle 14 such that the remote units 30 are arranged on four sides of the vehicle 14. The vehicle 14 is driven and each of the wind sensors 46 is exposed to wind. One of the arrows 28 on the display 22 is illuminated when a corresponding one of the wind sensors 46 detects a wind speed that exceeds the trigger wind speed. The illuminated arrow 28 alerts the driver 32 to the direction of the wind thereby facilitating the driver 32 to steer the vehicle 14 to accommodate a force imparted on the vehicle 14 by the wind.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle safety assembly configured to issue an alert when a vehicle is exposed to high winds, said assembly comprising:
a housing being configured to be positioned within a vehicle;
a control circuit being positioned within said housing;
a display being coupled to said housing;
a plurality of remote units, said remote units being configured to be distributed around four sides of the vehicle wherein each of said remote units detect wind, each of said remote units being in communication with said display, said display displaying an alert when a detected wind speed exceeds said trigger wind speed thereby alerting a driver of the vehicle to the detected wind, wherein each of said remote units comprises a base having a top side and a bottom side and a dome being coupled to said top side, said dome being comprised of a rigid and air permeable material; and
a plurality of wind sensors, each of said wind sensors being attached to an associated one of said remote units wherein each of said wind sensors is configured to detect a direction and a speed of wind, each of said wind sensors being positioned beneath said dome on said associated remote unit.

2. The assembly according to claim 1, wherein said control circuit being configured to be electrically coupled to the vehicle, said control circuit including an electronic memory, said electronic memory containing a pre-determined trigger wind speed.

3. The assembly according to claim 1, wherein
said housing has a front side; and
said display being positioned on said front side, said display being electrically coupled to said control circuit, said display displaying indicia, said indicia comprising an image of a vehicle and a plurality of arrows, each of said arrows pointing toward an associated one of four sides of the image of the vehicle.

4. (canceled)

5. The assembly according to claim 1, wherein said bottom side of each of said remote units has an adhesive layer attached thereto, said adhesive layer being configured to adhesively engage an outside surface of the vehicle such that said remote units are retained on the vehicle.

6. (canceled) The assembly according to claim 1, wherein.

7. The assembly according to claim 6, wherein:
said display displaying a plurality of arrows; and
each of said wind sensors is electrically coupled to said control circuit, said alert comprising one of said arrows on said display being illuminated corresponding to a direction of the detected wind with respect to the vehicle.

8. A vehicle safety assembly configured to issue an alert when a vehicle is exposed to high winds, said assembly comprising:
a housing being configured to be positioned within a vehicle, said housing having a front side;
a control circuit being positioned within said housing, said control circuit being configured to be electrically coupled to the vehicle, said control circuit including an electronic memory, said electronic memory containing a pre-determined trigger wind speed;
a display being coupled to said housing, said display being positioned on said front side, said display being electrically coupled to said control circuit, said display displaying indicia, said indicia comprising an image of a vehicle and a plurality of arrows, each of said arrows pointing toward an associated one of four sides of the image of the vehicle;
a plurality of remote units, said remote units being configured to be distributed around four sides of the vehicle wherein each of said remote units detect wind, each of said remote units being in communication with said display, said display displaying an alert when a detected wind speed exceeds said trigger wind speed thereby alerting a driver of the vehicle to the detected wind, each of said remote units comprising:
a base having a top side and a bottom side and a dome being coupled to said top side, said dome being comprised of a rigid and air permeable material, said bottom side of each of said remote units having an adhesive layer attached thereto, said adhesive layer being configured to adhesively engage an outside surface of the vehicle such that said remote units are retained on the vehicle, said remote units being configured to be distributed around four sides of the vehicle, and
a plurality of wind sensors, each of said wind sensors being attached to an associated one of said remote units wherein each of said wind sensors is configured to detect a direction and a speed of wind, each of said wind sensors being positioned beneath said dome on said associated remote unit, each of said wind sensors being electrically coupled to said control circuit, said display displaying an alert when a detected wind speed exceeds said trigger wind speed, said alert comprising one of said arrows on said display being illuminated corresponding to a direction of the detected wind with respect to the vehicle.
